(19) United States
(12) Patent Application Publication
(10) Pub. No.: US 2007/0159854 A1
(43) Pub. Date: Jul. 12, 2007

(54) Light emitting apparatus

(75) Inventors: Hideki Kokubu, Aichi (JP); Takayuki Kamiya, Aichi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/649,313

(22) Filed: Jan. 4, 2007

(30) Foreign Application Priority Data
Jan. 11, 2006 (JP) P2006-003282

(51) Int. Cl. F21V 7/04; F21V 21/08

(52) U.S. Cl. 362/634; 362/632; 362/615; 362/396

(57) ABSTRACT

It is a light emitting apparatus having a light source, and also having a light guide element into which light from the light source is guided. The light source is accommodated in an accommodating portion formed a top-surface side of the light emitting element. In the bottom surface of the light guide element, a light emitting portion is formed at a portion which is located away from places directly below the light source and directly below an optical axis of the light source and which extends from a region placed obliquely frontwardly from the light source to a region placed laterally from the light source.

### BACKGROUND OF THE INVENTION

1. Field of the Invention

The present invention relates to a light emitting apparatus. More particularly, the present invention relates to an improvement of a light emitting apparatus configured to emit light by converting light outputted from a light source into a linear or planar light beam through a light guide element.

2. Description of the Related Art

A light emitting apparatus adapted to obtain a linear or planar light beam by using a light source and a light guide element is utilized for various uses. FIG. 7 shows the general configuration of such a light emitting apparatus. In the light emitting apparatus 100, a light guide element 102 is disposed in front of a light source 101. Light outputted from the light source 101 is guided into the light guide element 102 from an end surface 193 thereof. Subsequently, the incident light is guided in the light guide element 102. Finally, the guided light is externally radiated as a planar light beam from a side surface (or light emitting surface) 104 of the light emitting element 102.

Incidentally, techniques relating to a structure for mounting a light emitting apparatus are disclosed in JP-2001-180373.

Similarly to an example shown in FIG. 7, generally, a conventional light emitting apparatus is configured so that a light emitting surface is placed in front of the light source (that is, the light source and the light emitting surface are arranged in a linear positional relationship). Thus, the total length of the apparatus is large. Meanwhile, there are many cases where a light emitting apparatus should be placed in a limited space, for example, a case where a light emitting apparatus is used for illuminating a vehicle interior. Thus, it is requested to reduce the length of a light emitting apparatus.

On the other hand, to achieve the essential functions of a light emitting apparatus, for example, to achieve illumination or presentation effects using light, a light emitting apparatus is requested to assure a sufficient light emitting are or length.

Accordingly, a problem to be solved by the invention is to provide a light emitting apparatus enabled to reduce a total length thereof and to assure a sufficient light emitting area or length.

### SUMMARY OF THE INVENTION

To solve the above problem, according to the invention, there is provided a light emitting apparatus of the following configuration. That is, this light emitting apparatus having a light source, and also having a light guide element into which light from the light source is guided. The light source is accommodated in an accommodating portion formed a top-surface side of the light emitting element. In the bottom surface of the light guide element, a light emitting portion is formed at a portion which is located away from places directly below the light source and directly below an optical axis of the light source and which extends from a region placed obliquely frontwardly from the light source to a region placed laterally from the light source.

With the configuration according to the invention, the light source accommodating portion is provided in the light guide element. Also, the light source is disposed in the accommodating portion. This eliminates the necessity for additionally providing a space in which the light source is placed. Consequently, the light emitting apparatus, whose total length is short, is obtained. Additionally, instead of forming a light emitting portion at a part, which is placed directly below the optical axis of the light source, in the bottom surface of the light source, the light emitting portion is formed at the portion which is located away from places directly below the light source and directly below the optical axis of the light source and which extends from the region placed obliquely frontwardly from the light source to the region placed laterally from the light source. Consequently, a sufficient light emitting area can be assured. Also, the configuration, in which the light emitting portion is provided at the portion that is located at an offset position from the light source and the optical axis of the light source, eliminates significant variation in intensity of emitted light, which is caused by placing a part of the light emitting surface just close to the light source or to the optical axis of the light source. That is, the variation in the intensity of the emitted light can be alleviated.

As described above, with the configuration according to the invention, both the miniaturization of a light emitting apparatus and the assurance of a sufficient light emitting area can be achieved. Additionally, light having a small variation in intensity thereof cab be obtained.

### BRIEF DESCRIPTION OF THE DRAWINGS

FIGS. 1A to 1C are diagrams illustrating an LED light emitting apparatus according to an embodiment of the invention and a cover used for the LED light emitting apparatus. FIG. 1A is a perspective diagram illustrating the LED light emitting apparatus. FIGS. 1B and 1C are perspective diagrams illustrating the cover.

FIGS. 2A to 2F are diagrams illustrating the LED light emitting apparatus. FIG. 2A is a front diagram illustrating the LED light emitting apparatus. FIG. 2B is a left side diagram illustrating the LED light emitting apparatus. FIG. 2C is a plan diagram illustrating the LED light emitting apparatus. FIG. 2D is a right side diagram illustrating the LED light emitting apparatus. FIG. 2E is a rear diagram illustrating the LED light emitting apparatus. FIG. 2F is a bottom diagram illustrating the LED light emitting apparatus.

FIGS. 3A to 3C are cross-sectional diagrams illustrating the LED light emitting apparatus. FIG. 3A is a cross-sectional diagram taken on line A-A shown in FIG. 2F. FIG. 3B is a cross-sectional diagram taken online B-B shown in FIG. 2F. FIG. 3C is a cross-sectional diagram taken on line C-C shown in FIG. 2F.

FIG. 4 is a diagram illustrating a circuit portion of the LED light emitting apparatus 1.

FIGS. 5A and 5B are diagrams illustrating an example of use of the LED light emitting apparatus. FIG. 5A is a diagram illustrating a state in which the LED light emitting apparatus 1 is not mounted on an inside handle vessel. FIG. 5B is a diagram illustrating a state in which the LED light emitting apparatus 1 is mounted on the inside handle vessel.

FIG. 6 is a diagram illustrating another example of use of the LED light emitting apparatus in another mounting mode.

FIG. 7 is a diagram illustrating an example of a conventional light emitting apparatus.

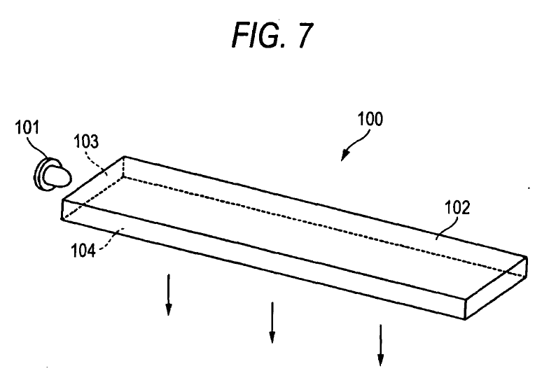

### DESCRIPTION OF THE PREFERRED EMBODIMENTS

### (Light Source)

The light source used in the light emitting apparatus according to the invention is not limited to a specific kind of a light source. For example, LED lamps and LED valves may be used as the light source used in the light emitting apparatus according to the invention. Preferably, an LED lamp is used, because the LED lamp is compact, so that the miniaturization of the apparatus can be achieved. Also, the LED lamp has advantages in that an amount of heat generated by the LED lamp is small, and that influence of heat on surrounding members (for example, light guide elements and covers) can be reduced. Moreover, the LED lamp has additional advantages in that electric drive power therefor is low, and that the LED lamp has a long life. The kind of the LED lamp is not limited to a specific one. The LED lamps of various types, such as a shell-type and a chip-type, can be employed.

The color of light outputted from the light source can optionally be selected. For example, LED lamps adapted to emit light of wavelengths in a visible range, such as white light, red light, orange color light, green light, and blue light, can be employed. Alternatively, an LED lamp adapted to radiate light obtained by converting the conversion of the wavelength of a part of light outputted from an LED chip through a phosphor and by mixing the light outputted from the LED chip with fluorescence can be employed. The phosphor can be contained in, for example, a sealing resin for an LED lamp. Alternatively, a layer including a phosphor may be provided on a surface of the sealing resin. Alternatively, an LED lamp including a plurality of LED chips of the same kind or different kinds can be used. For example, an LED lamp configured by mounting an LED chip corresponding to each of red, green, and blue light on a substrate maybe used. Then, light of a desired color can be emitted by controlling a light emitting mode of each of the LED chips. Consequently, a light emitting apparatus adapted to emit light of a desired color can be configured.

### (Light Guide Element)

The light emitting apparatus according to the invention has a light guide element. Light outputted from the light source is converted by the light guide element into a linear or planar light beam. An accommodating portion (hereunder sometimes referred to as a light source accommodating portion) is formed at a top-surface-side portion of the light guide element. For example, a concave portion is provided in the top-surface-side portion of the light guide element, and is used as the light source accommodating portion. The entire light source is not necessarily accommodated in the light source accommodating portion. Incidentally, preferably, substantially the entire light output side of the light source is covered with the wall surface of the light source accommodating portion so that light outputted from the light source is efficiently introduced into the light guide element through the wall surface opposed to the light output side of the light source in the light source accommodating portion.

Preferably, the circuit portion for the light source is configured to be accommodated in the light source accommodating portion. With such a configuration, the necessity for additionally providing a space for the circuit portion is eliminated. Consequently, further miniaturization of the apparatus can be achieved.

Preferably, the accommodating portion is constituted by a concave portion opened at an end side of the light guide element. Such a configuration of the accommodating portion facilitates an operation of accommodating the light source. Also, such a configuration of the accommodating portion facilitates replacement of the light source.

The light emitting portion is formed in a part of the bottom surface portion of the light guide element. The “light emitting portion” according to the invention is defined to be a region, in which light is radiated from the light emitting apparatus when the light emitting apparatus is used. Therefore, the light emitting portion may be formed as a result of shielding a part of the bottom surface of the light guide element by a part of a mounting counterpart member.

The light emitting portion is formed at a part, which is located away from places directly below the light source and directly below an optical axis of the light source, in the bottom surface portion of the light guide element. According to the invention, a relatively large light emitting area is assured by forming the light emitting portion, which extends from a region placed obliquely frontwardly from the light source to a region placed laterally from the light source, in this part. Preferably, the light emitting portion continuously extending from a region placed obliquely frontwardly from the light source to a region placed obliquely rearwardly from the light source is formed in this part. With such a configuration, the light emitting area can be increased.

The shape of the light emitting portion is not limited to a specific shape. For example, the light emitting portion is linearly shaped. To reduce variation in brightness of light radiated from the light emitting surface, preferably, the light emitting surface is provided in parallel to the optical axis of the light source. Thus, a preferred embodiment of the invention is provided with a linear light emitting surface that is parallel to the optical axis of the light source.

The light emitting portion can be formed as follows. That is, a part of the bottom surface of the light guide element is masked with an opaque material. Thus, an exposed part of the bottom surface is used as the light emitting portion. For example, such masking can be performed by using, for example, a black resin, a coating material, and tape. Additionally, an example of the case, in which the light emitting portion is formed when the apparatus is used, is that when the light emitting apparatus is mounted at a predetermined place, a part of the bottom surface of the light guide element is exposed through an opening portion provided in the mounting counterpart member (the rest of the bottom surface of the light guide element is shielded), so that the exposed part constitutes the light emitting portion.

The material of the light guide element is not limited to a specific material, as long as the material of the light guide element can transmit light outputted from the light source. Preferably, the light guide element is made of a material that can easily be processed and that excels in durability. For example, an acrylate resin, a polymethyl methacrylate (PMMA), a polyethylene terephthalate (PET), and a polycarbonate resin can be used as the material of the light guide element.

Light diffusion processing can be performed on the bottom surface (at the side at which the light emitting portion is formed), the top surface and/or the side surface of the light guide element. The light diffusion processing is performed to promote the diffusion of light in the light guide element, and to enable favorable emission of light from the light emitting portion by controlling light distribution in the light guide element. An example of the light diffusion processing is the formation of an uneven portion. Incidentally, the uneven portion includes groove-shaped portions, such as a triangular groove, a rectangular groove, and a rounded groove, and pit-like portions. A plurality of differently-shaped uneven portions can be combined with one another. Such uneven portions can continuously be formed. Also, dot-like portions can discontinuously be formed. The uneven portions can be shaped either regularly or randomly. Examples of a regular pattern are a matrix-like pattern of dots of a desired size, a slit-like pattern, and a grid-like pattern.

Such an uneven form can be formed by shaving off a part of the surface of the light guide element using a needle-like or serrated processing tool or by performing cutting or grinding on the surface of the light guide element. Alternatively, such an uneven portion can be formed by performing die-forming using a die, by which a desired uneven portion is formed, to thereby manufacture the light guide element.

Preferably, the light guide element is adapted to contain the light diffusion material, such as silica and oxidized titanium. The diffusion of light in the light guide element is promoted by using the light diffusion material. Consequently, an amount of light reaching the light emitting surface formed on the light guide element is increased. Also, variation in brightness of light emitted from the light emitting surface is reduced. Therefore, especially in a case where the light emitting surface is formed in the bottom surface of the light guide element to the region placed obliquely rearwardly from the light source, it is effective to adapt the light guide element to contain the light diffusion material.

### (Cover)

An embodiment of the invention has a cover adapted to cover the top surface side and the lateral side surface of the light guide element. The cover protects the light guide element and the light source and enhances the design ability of the apparatus. On the other hand, in a case where a cover made of a material adapted to reflect light radiated from the optical source, light emitted from the top surface side of the light guide element can be reflected to the light guide element by the cover. Consequently, loss of light can be reduced. Also, an amount of light emitted from the light emitting surface is increased. Further, light can selectively be emitted from the light emitting surface, without performing light reflection/diffusion processing on surfaces other than the light emitting surface of the light guide element, by employing a light reflection cover. Consequently, the configuration of the light guide element is simplified. The process of manufacturing the light guide element is also simplified. Unfavorable leakage of light from the top surface of the cover can be reduced by employing the light reflection cover. Incidentally, even in a case where the light reflection cover is used, light reflection/diffusion processing may be performed on the surfaces other than the light emitting surface of the light guide element.

For example, a polypropylene (PP) resin, a polyethylene (PE) resin, an ABS resin, and other general-purpose resins can be used as the material of the cover.

According to an embodiment of the invention, a specific fitting structure is provided at an end of the cover. The light emitting apparatus according to this embodiment can surely be fixed to the mounting counterpart member by utilizing the specific fitting structure. For example, the fitting means can be constituted by a projection portion (hereunder referred to as “a first projection portion”, for convenience of description) having a first surface which is substantially flush with the light emitting surface of the light guide element, a second surface which is parallel to the first surface and is opposed to the second surface, and a catching claw formed on the second surface. In a case where such a fitting means is employed, the mounting counterpart member, on which the light emitting apparatus is mounted, is provided with a mounting surface opposed to the light emitting surface of the light guide element, and a projection portion that is parallel to the mounting surface and that has a concave portion or a through hole. When the light emitting apparatus is mounted thereon, the projection portion is inserted between the first surface and the second surface of the first projection portion. Then, the catching claw formed on the second surface is caught in the concave portion or the through hole of the projection portion. Incidentally, the first surface and the second surface are parallel to the light emitting surface of the light guide element. Thus, in a case where the light emitting apparatus is moved by simultaneously maintaining a state in which the light emitting surface of the light emitting apparatus is parallel to the mounting surface of the mounting counterpart member and to the projection portion, the protrusion of the mounting counterpart member can be inserted in to and fitted into the between the first surface and the second surface. That is, the light emitting apparatus can be mounted on the mounting surface only by being moved in parallel to the mounting surface. Therefore, an operation of mounting the apparatus is simple. Thus, even in a case where a sufficient space cannot be assured above the mounting surface, the light emitting apparatus can be mounted thereon. Incidentally, the mounting structure disclosed in JP-A-2001-180373 (Patent Document 1) is required to assure a sufficient space above an inside handle vessel, which is the mounting counterpart member. Therefore, the mounting structure disclosed in JP-A-2001-180373 largely differs from the mounting structure according to the invention.

A cylinder opened at a front end side and a cover body side can be employed as an embodiment of the first projection portion employing the fitting structure of the light emitting apparatus. The strength (or impact resistance) of the first projection portion can be enhanced. Also, the positioning of the apparatus at the fitting of the projection portion can surely be achieved. Additionally, the apparatus can be prevented from being displaced.

According to a preferred embodiment of the invention, the second projection portion is provided on the cover. The second projection portion is provided at the end portion opposite to the side at which the first projection portion is provided. The bottom surface of the second projection portion is substantially flush with the light emitting surface of the light guide element. As a result of providing such a second projection portion, the second projection portion serves as a guide when the light emitting apparatus is mounted. Thus, the mounting of the apparatus can more smoothly be achieved. Also, when the light emitting apparatus is mounted, the adhesion between the light emitting surface and the mounting surface is enhanced. Further, in a case where a hole or a gap, into which the second projection portion is inserted, is preliminarily formed, the light emitting apparatus can more surely be fixed to the mounting counterpart member by fitting the second projection portion into the hole or the gap. Thus, the second projection portion may be also used as a fixing means.

### First Embodiment

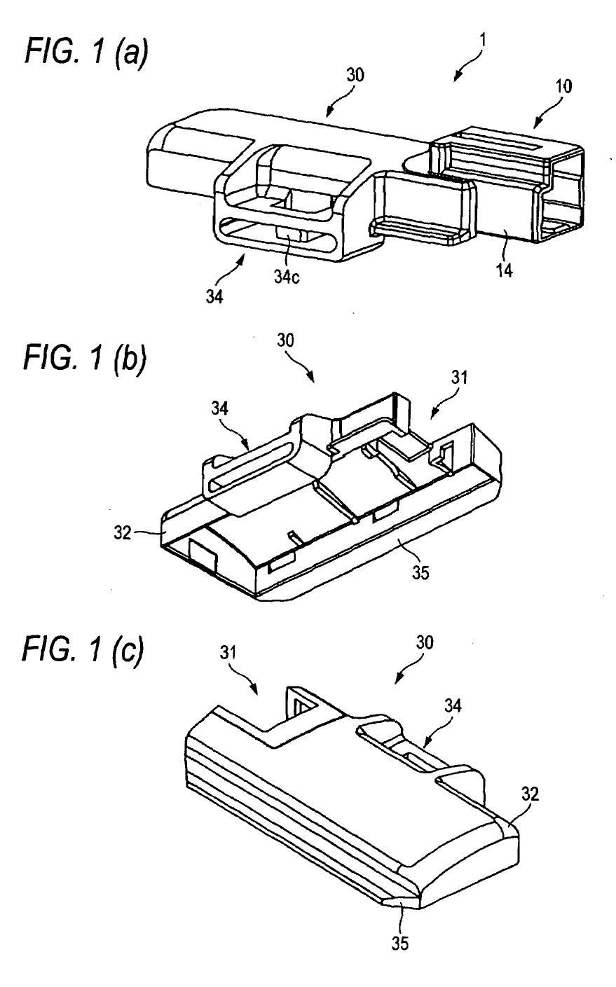

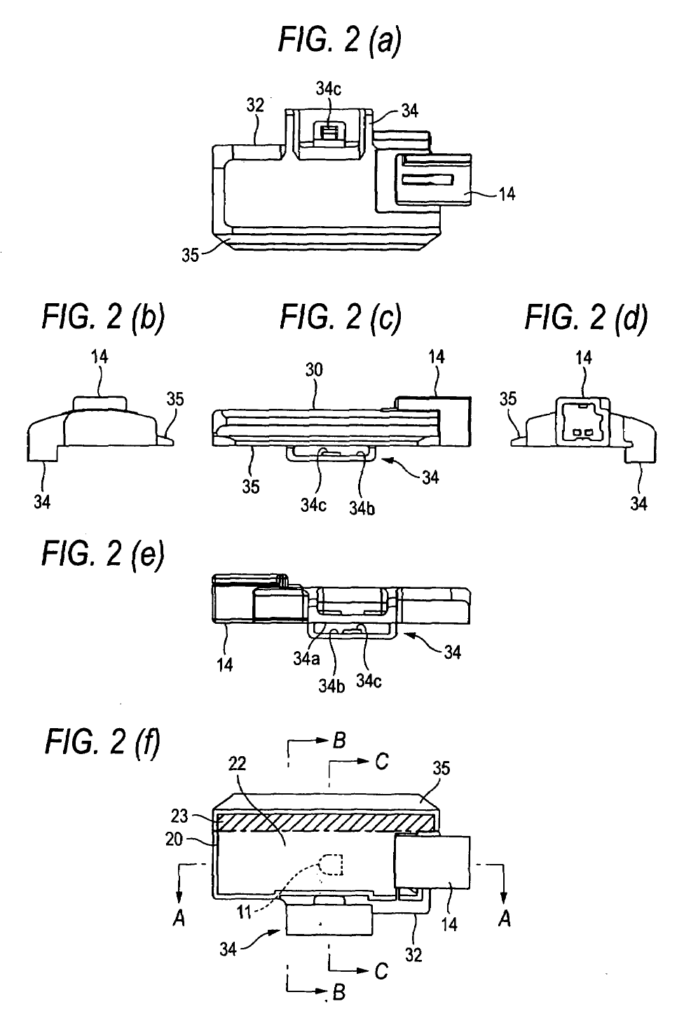

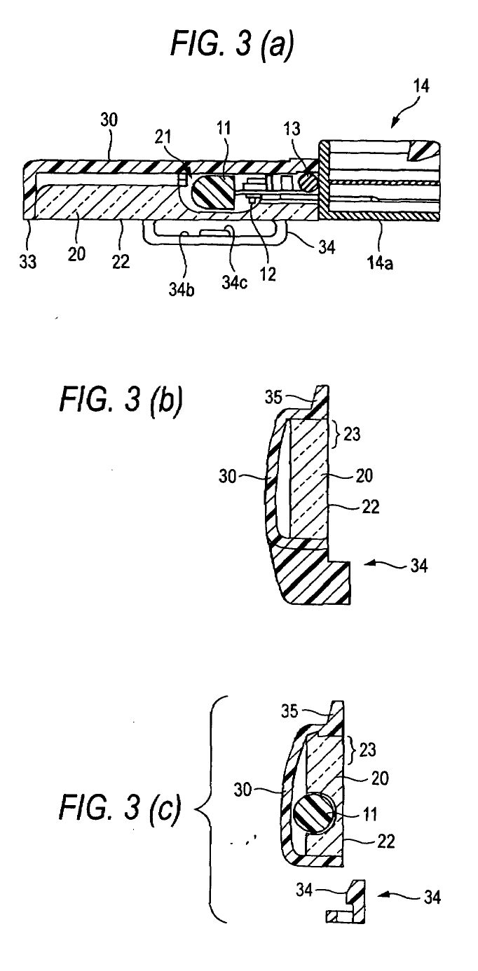

Hereinafter, the invention is described in detail with reference to an embodiment. FIGS. 1A to 3C illustrate an LED light emitting apparatus according to the embodiment. FIG. 1A is a perspective diagram illustrating the LED light emitting apparatus 1. FIGS. 1B and 1C are perspective diagrams illustrating a cover 30 used for the LED light emitting apparatus 1. FIGS. 2A to 2F are a plan diagram, a left-side diagram, a front diagram, a right side diagram, a rear diagram, and a bottom diagram, which illustrate the LED light emitting apparatus, respectively. FIGS. 3A to 3C are across-sectional diagram taken on line A-A shown in FIG. 2F, a cross-sectional diagram taken on line B-B shown in FIG. 2F, and a cross-sectional diagram taken on line C-C shown in FIG. 2F, respectively.

The LED light emitting apparatus 1 roughly includes a lamp unit 10, a light guide element 20, and a cover 30. The lamp unit 10 has an LED lamp 11, and also has a zener diode 12, a resister 13, and a case portion 14, which serve as an LED lighting circuit protection components.

The LED lamp 11 is of the shell type. The LED lamp 11 of the present embodiment includes a blue light emitting diode formed of a Group III nitride compound semiconductor device. Also, a sealing resin for the LED lamp 11 includes a yellow (YAG) phosphor. Consequently, the LED lamp 11 radiates white light generated by mixing blue light originated from the light emitting diode with yellow light originated from the phosphor. Incidentally, the LED lamp is small in electric power consumption and in amount of heat generated therein, and has a long life. Therefore, the LED lamp is suitable for continuously being turned on for a long time.

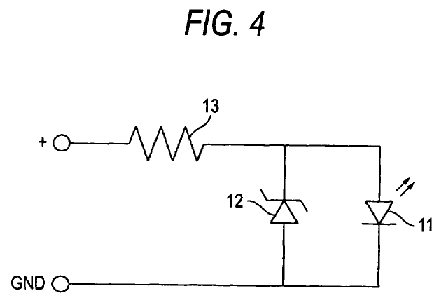

A metal plate is used in a circuit portion of the lamp unit 10. The LED lamp 11, the zener diode 12, and the resister (or resistance element) 13 are mounted (or connected) onto the metal plate to thereby form a circuit shown in FIG. 4. The present embodiment employs an SMD zener diode to miniaturize the apparatus. On the other hand, the present embodiment employs a lead resister to enhance reliability.

The cover 30 is made of a white resin (a polypropylene resin in the present embodiment) and is widely opened at a side thereof. A lateral surface side portion of the cover 30 has an opening portion (or side opening portion) 31 formed to have a U-shape in plan view. The lamp unit 10 is inserted into the side opening portion 31. The cover 30 and the lamp unit 10 are fixed by utilizing a catching claw (not shown) formed on a side wall of the case portion of the lamp unit 10.

As shown in FIGS. 2F, and 3A to 3C, the light guide element 20 is disposed in the cover 30. The light guide element 20 is made of a polycarbonate resin containing a light diffusion material and is tinged with opaque white. The light guide element 20 is shaped like a substantially flat plate. A concave portion 21 is formed on the top side of the light guide element 20 to extend from a substantially central portion to an end portion (see FIG. 3A). A part of the lamp unit 10, which is provided at the side of the LED lamp 11, is fitted into the concave portion 21. The concave portion 21 is opened at the side of an end thereof, and has a surface shape corresponding to the outer shape of the part of the lamp unit 10, which is provided at the side of the LED lamp 11. Consequently, the part of the lamp unit,10, which is provided at the side of the LED lamp 11, can smoothly be inserted into the concave portion 21 from a lateral direction. Additionally, after inserted thereinto, the lamp unit 10 can be fixed thereto by being positioned thereto. Also, the LED lamp unit 10 can be prevented from being displaced after inserted thereinto. Furthermore, light outputted by the LED lamp 11 can efficiently be guided into the light guide element 20 from the wall surface of the concave portion 21.

The bottom surface 22 of the light guide element 20 is a flat surface. The bottom surface 22 of the light guide element 20, the bottom surface 33 of the end portion of the cover 30, and the bottom surface 14a of the case portion 14 of the lamp unit 10 are substantially flush with one another (see FIG. 3A). A light emitting portion 23 is formed in a part of the bottom surface portion 22 of the light guide element 20. In the present embodiment, a shaded region in FIG. 2F is utilized as the light emitting portion 23. That is, when the LED light emitting apparatus 1 is used, a part of the bottom surface of the light guide element 22 is shielded by a mounting counterpart member (or mounting surface). Light is taken from an unshielded region (that is, the light emitting portion 23). The light emitting portion 23 is formed at a part, which is located away from places directly below the LED lamp 11 and directly below the optical axis of the LED lamp 11, to be in parallel to the optical axis of the LED lamp 11. Also, the light emitting portion 23 is formed in the bottom surface portion 22 of the light guide element 20 as an elongated portion which continuously extends from a region placed obliquely frontwardly from the LED lamp 11 to a region placed obliquely rearwardly from the LED lamp 11. Incidentally, although the light emitting portion 23 is formed in the present embodiment so that a part of the bottom surface 22 of the light guide element 20 is shielded when the light emitting apparatus is used, the light emitting portion may be formed by preliminarily masking a part of the bottom surface 22 of the light guide element 20.

A (first) projection portion 34 having a fitting means is formed at an end portion 32 of the cover 30. The first projection portion 34 is shaped like a cylinder, which is opened at a cover body side and a front end side. The first projection portion 34 has an inner wall surface 34a, which is substantially flush with the bottom surface 22 of the light guide element 20, and also has an inner wall 34b which is parallel to and is opposed to the inner wall surface 34a (see FIG. 2E). The inner wall surface 34b is provided with a catching claw 34c. Incidentally, impact resistance is enhanced by shaping the first projection portion 34 like a cylinder.

On the other hand, the cover's end portion opposite to the side, at which the first projection portion 34 is formed, has a bottom surface side part (or second projection part 35), the entirety of which is protruded. The bottom surface of the second projection portion 35 is substantially flush with the bottom surface 22 of the light guide element 20. A top surface side part of the second projection portion 35 is tapered toward a front end.

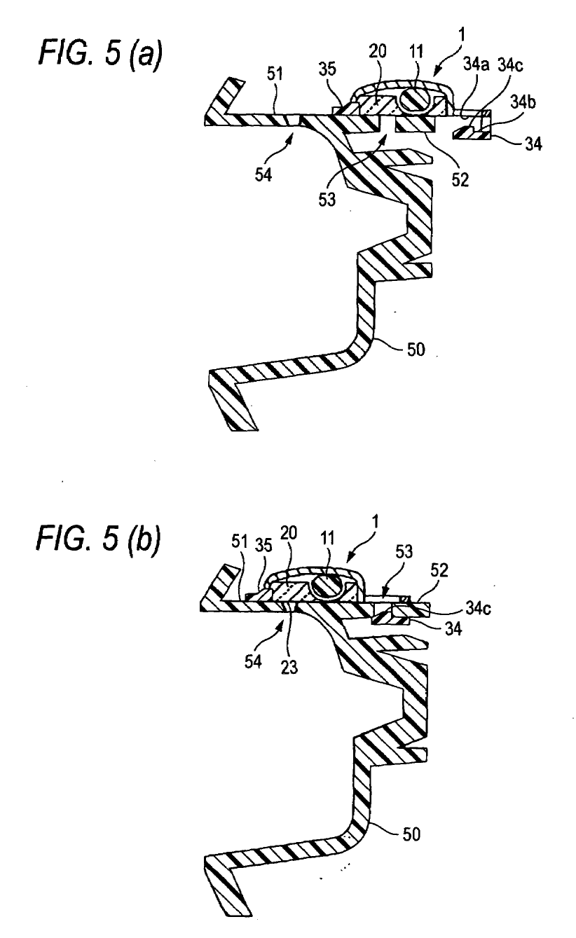

FIGS. 5A and 5B are diagrams illustrating an example of application of the LED light emitting apparatus 1 to illumination of an inside handle portion of a vehicle. FIG. 5A is a diagram illustrating a state in which the LED light emitting apparatus 1 is not mounted on an inside handle vessel 50. FIG. 5B is a diagram illustrating a state in which the LED light emitting apparatus 1 is mounted on the inside handle vessel 50. A rear-surface-side upper part of the inside-handle vessel 50 serves as a mounting part on which the LED light emitting apparatus 1 is mounted. The mounting part is provided with a protrusion 52. A through hole 53 is formed in the protrusion 52. Additionally, the entire mounting surface 51 is flat. When the LED light emitting apparatus 1 is mounted thereon, first, the LED light emitting apparatus 1 is put on the mounting surface 51 (in a state shown in FIG. 5A) by downwardly directing the bottom surface 22 (the opening side of the cover) of the light guide element 20, as viewed in FIG. 5A. Subsequently, the LED light emitting apparatus is moved or slid to the left, as viewed in this figure. Because of the facts that the entire bottom surface side of the LED light emitting apparatus 1, which is opposed to the mounting surface 51, is substantially flush with the mounting surface 51, and that the second projection portion 35 of the cover 30 serves as a guide, the LED light emitting apparatus 1 can smoothly be moved along the mounting surface 51.

The protrusion 52 of the mounting part is inserted into the first projection portion 34 of the cover 30 by moving the LED light emitting apparatus 1, as described above. In a state in which the protrusion 52 is completely inserted thereinto, the catching claw 34c provided in the first projection portion 34 is caught in the through hole 53 of the protrusion 52. Thus, the protrusion 52 of the mounting part is fitted into the first projection 34 of the cover 30. Consequently, the LED light emitting apparatus 1 is fixed to the mounting part of the inside handle vessel 50 by being positioned thereat. Also, such a fitting structure is employed so that the LED light emitting apparatus 1 can be prevented from being displaced. Incidentally, the adhesion between the mounting surface 51 and the bottom surface 22 of the light guide element 20 is enhanced by providing the second projection portion 35 on the cover 30 of the LED light emitting apparatus 1. This also serves to prevent the LED light emitting apparatus 1 from being displaced.

As described above, the LED light emitting apparatus 1 can be mounted on and fixed to the inside handle vessel 50 by a very simple method of laterally moving the LED light emitting apparatus 1. Additionally, the LED light emitting apparatus 1 can be mounted there on only by laterally being moved. Therefore, the invention can be applied to a case where a sufficient space is not present above the inside handle vessel 50.

Light is taken from the LED light emitting apparatus 1 mounted on an upper part of the inside handle vessel 50.

The LED light emitting apparatus 1 is connected to electrical wiring provided in a vehicle, and is controlled by a controller provided in the vehicle. For example, the controller controls the turning on/off of the LED lamp 11 in response to the opening/closing of a door. When the LED lamp 11 is turned on, light radiated from the LED lamp 11 is irradiated onto an end surface (that is, an end surface opposed to a light emitting region of the LED lamp in the concave portion) of the light guide element 20. Thus, the irradiated light is introduced into the light guide element 20. The light having been introduced into the light guide element 20 is guided in the light guide element 20 while diffused by the diffusion material (for example, silica). Finally, apart of the light is radiated from the light emitting portion 23 that is formed in the bottom surface portion 22 of the light guide element 20. A slit-like light transmitting portion 54 is formed at a position, to which the light emitting portion 23 is opposed, in the mounting part of the inside handle vessel 50. The light radiated from the light emitting portion 23 is taken to the vehicle interior through the slit-like light transmitting portion 54. Consequently, the inside handle portion is illuminated with white light.

Incidentally, because the cover 30 is formed of a white resin, light radiated from the top surface side of the light guide element 20 is reflected and diffused on a surface of the cover 30, and is converted into light traveling toward the light guide element 20. Consequently, light is introduced again into the light guide element 20. Thus, the rate of utilization of light is enhanced. Also, brightness is uniformized. Additionally, as described above, in the LED light emitting apparatus 1, the light emitting portion 23 is formed in the bottom surface portion 22 of the light guide element 20 as the elongated portion which continuously extends from a region placed obliquely frontwardly from the LED lamp 11 to a region placed obliquely rearwardly from the LED lamp 11. However, light is favorably diffused in the light guide element 20 due to a diffusion effect caused by the diffusion material. Thus, light beams, which are adapted so that a difference in brightness among the light beams is small and that the light beams have functionally sufficient values of brightness, are radiated from the light emitting portion 23.

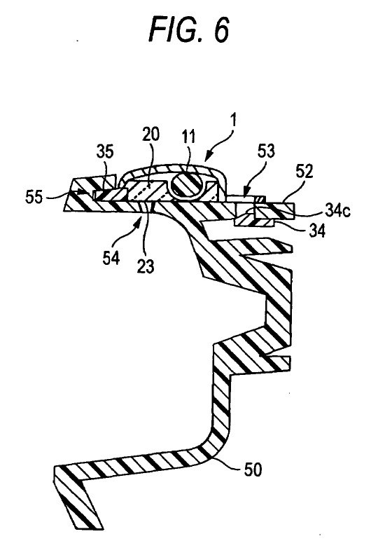

FIG. 6 illustrates another example of use of the LED light emitting apparatus in another mounting mode. In this example, a mounting groove 55 is provided in an upper part of the inside handle vessel 50. In the LED light emitting apparatus 1 according to this example, the first projection portion 34 is fitted onto the protrusion 52 of the mounting counterpart member. Additionally, the second projection portion 35 is inserted into the mounting groove 55. Thus, the LED light emitting apparatus 1 is fixed to the mounting part of the inside handle vessel 50. Consequently, the LED light emitting apparatus 1 can more surely be fixed thereto. Thus, this mounting mode is more effective in preventing the LED light emitting apparatus 1 from being displaced and from being slipped off.

Although the LED light emitting apparatus according to the present embodiment has only one LED, the LED light emitting apparatus may be configured to have a plurality of LED lamps.

The light emitting apparatus according to the invention can be utilized for various kinds of light emission indication and illumination. That is, the light emitting apparatus according to the invention can preferably be applied to the light indications in an instrument panel and to the illumination of a vehicle interior (for example, inside handle illumination, map lamps, and foot light).

The invention is not limited to the foregoing descriptions of the mode for carrying out the invention and the embodiments of the invention. The invention includes various modifications that can easily be conceived by those skilled in the art without departing from the scope of the appended claims.

What is claimed is:

1. A light emitting apparatus, comprising:
a light source; and
a light guide element, into which light from said light source is guided;
wherein said light source is accommodated in an accommodating portion which is formed at a top-surface side of said light guide element; and
in a bottom surface of said light guide element, a light emitting portion is formed at a portion which is located away from places directly below said light source and directly below an optical axis of said light source and which extends from a region placed obliquely frontwardly from said light source to a region placed laterally from said light source.

2. The light emitting apparatus according to claim 1, wherein a circuit portion for said light source is also accommodated in said accommodating portion.

3. The light emitting apparatus according to claim 1, wherein said accommodating portion includes a concave portion opened at a side of an end of said light guide element.

4. The light emitting apparatus according to claim 1, wherein said light emitting portion extends in parallel to the optical axis of said light source.

5. The light emitting apparatus according to claim 1, wherein in the bottom surface of said light guide element, said light emitting portion is formed at the portion which is located away from places directly below said light source and directly below under the optical axis of said light source, to continuously extend a region placed obliquely rearwardly from said light source.

6. The light emitting apparatus according to claim 1, wherein said light guide element includes a light diffusion material.

7. The light emitting apparatus according to claim 1, further comprising:
a cover, which is configured to cover a top surface side and a lateral surface side of said light guide element and which is made of a material adapted to reflect light outputted from said light source.

8. The light emitting apparatus according to claim 1, further comprising:
a cover configured to cover a top surface side and a lateral surface side of said light guide element, and to having a fitting means at a side of an end thereof.

9. The light emitting apparatus according to claim 8, wherein said fitting means includes a first projection portion which comprises a first surface configured to be substantially flush with the light emitting surface, a second surface configured to extend in parallel with said first surface and to be opposed to said first surface, and a catching claw formed on said second surface.

10. The light emitting apparatus according to claim 9, wherein said projection portion is shaped like a cylinder, which is opened at a side of a front end thereof and is also opened at a side of a body of said cover.

11. The light emitting apparatus according to claim 8, wherein said cover further comprises a second projection portion configured to have a bottom surface which is substantially flush with the light emitting surface.
